(19) United States
(12) Patent Application Publication
(10) Pub. No.: US 2006/0066454 A1
(43) Pub. Date: Mar. 30, 2006

(54) Earth magnetic field measurements with electronically switched current in a source loop to track a borehole

(75) Inventors: Arthur F. Kuckes, Ithaca, NY (US); Herbert Susmann, Ithaca, NY (US); Rahn Pitzer, Ithaca, NY (US)

Correspondence Address: JONES, TULLAR & COOPER, P.C., P.O. BOX 2266 EADS STATION, ARLINGTON, VA, 22202, US

(73) Assignee: Vector Magnetics LLC

(21) Appl. No.: 11/184,987

(22) Filed: Jul. 20, 2005

Related U.S. Application Data
(60) Provisional application No. 60/610,175, filed on Sep. 16, 2004.

(51) Int. Cl. G01V 3/00

(52) U.S. Cl. 340/854.1

(57) ABSTRACT

Methods and apparatus for precisely tracking a borehole using electronically controlled DC current switching in a source loop in the vicinity of the borehole together with measurements of the apparent Earth's magnetic field are disclosed. A field averaging method optimally gives the location of points in the borehole in the presence of intense magnetic noise. The expected uncertainty of these locations can be found from a method of generating an ensemble of simulated surveys using a noise characterization parameter found from apparent Earth field measurements. Time synchronization between apparent Earth field measurements and the instants of switching to positive current flow into the loop is found using a correlation method in conjunction with different time durations for positive and negative current flow in the source loop.

### BACKGROUND OF THE INVENTION

This application claims the benefit of U.S. Provisional Application No. 60/610,175, filed Sep. 16, 2004, the disclosure of which is hereby incorporated herein by reference.

This invention relates, in general, to an apparatus and method for tracking the drilling of boreholes for the construction of pipelines, electrical and fiber optic cables and the like deep under industrialized areas where much magnetic noise is present.

Drilling boreholes under natural and man made obstacles for pipeline and cable distribution networks has developed greatly in recent years. The use of current carrying wires in the vicinity of the borehole in conjunction with electromagnetic field detectors in the drilling assembly has been particularly important for precisely tracking such boreholes. This success has brought with it a desire to drill boreholes deeper in the ground and to drill in urban areas where much magnetic noise may be present. This invention overcomes many of the resulting concerns.

The intrinsic problems are several. To track the drilling of a borehole within a right of way with a fixed aperture deeper in the Earth requires a proportionately more precise determination of the electromagnetic field being utilized for guidance. At the same time, the magnetic field generated by a given surface source configuration of current carrying wires decreases rapidly with the distance away from them. In addition, the random electromagnetic field fluctuations, which exist in the earth from a variety of sources, are much greater in urban areas than in rural areas. Unexpected solar magnetic storms also create havoc with otherwise easy borehole tracking. Finally, in urban areas it is often not possible to deploy electric current source loops with optimal configuration. There is, therefore, an important need for a flexible tracking system which can be adjusted to overcome the effects of unexpected, and often frequent, magnetic noise which appears after a drilling project has begun, and after the methods of borehole tracking have been decided upon.

To overcome the foregoing problems, the need for better signal averaging becomes ever more important. For most systems, precision is directly related to the time taken for signal averaging, but since the time taken for signal averaging while drilling a borehole adds directly to the time required to complete a project, which is usually directly proportional to the total project cost, the requirement to minimize the time required for borehole tracking and being able to set the signal averaging time to the conditions present is very important.

A dominant borehole tracking system using a configuration of current carrying wires at the surface is the “True Tracker” system, which is based upon U.S. Pat. No. 4,875,014, issued to Roberts and Walters. In this system, a DC electric current, usually from a welder, is manually connected, first in one polarity and then in the other, to a loop of wire at the Earth's surface. Two sets of three-vector-component, apparent Earth field measurements are taken, and these sets are analyzed to determine the coordinates of the present sensor location. To improve precision, practitioners of this method use the procedure, disclosed in U.S. Pat. No. 4,875,014, of averaging such repeated, independent sensor location coordinate determinations. This has the important feature of providing the driller with data from which a direct evaluation of the standard deviation of the coordinate determinations and of the overall location uncertainty can be computed. However, manual switching of polarity is usually not a satisfactory way to do extensive signal averaging to overcome the effects of intense magnetic noise. In addition, when intense magnetic noise is present, intrinsic systematic errors arise with coordinate averaging, so that reliable location determination is not possible even if a large number of such coordinate determinations are made and averaged.

U.S. Pat. No. 6,466,020 discloses a system wherein two electromagnetic field components perpendicular to the borehole are measured, and these measurements, together with the measured depth along the borehole, i.e., the length of drill pipe in the borehole, are used to determine borehole location. This patent discloses the use of an AC power source with synchronous AC field averaging, which can provide good precision even in the presence of intense magnetic noise. The signal averaging time required is governed by the wire configuration, the electric power used, and the precision required. In general, the signal averaging time required for any system, to overcome the effects of random noise, increases as the square of the precision required. Safety requirements dictate a limit to the maximum voltage, and thus the maximum current flow, attainable in the wire loop. Accordingly, the two constraints of (1) a limit on the maximum source voltage and (2) a sinusoidal AC current source, result in synchronous AC signal averaging, which requires double the time to attain a given location precision than is required by the DC current switching apparatus and field averaging method disclosed herein.

### SUMMARY OF THE INVENTION

In accordance with preferred embodiments of the invention, improved apparatus and methods for precisely tracking the path of a borehole in the Earth are disclosed. The invention discloses apparatus and methods for the precise evaluation of an electromagnetic field at a point in a borehole, where that field is generated from electric current flow in a loop of wire with a given configuration, particularly in the presence of intense magnetic noise. The measured field can be related to location using well-known methods, e.g. the methods disclosed in U.S. Pat. No. 6,466,020, the disclosure of which is hereby incorporated herein by reference. The apparatus and the methods disclosed herein are not only useful for tracking a drill head and its steering tool in a borehole while drilling the borehole along a prescribed path, but may also be used for other purposes such as surveying existing boreholes.

The present invention is based upon the use of electronically controlled switching apparatus to repetitively reverse the direction of current flow in a loop of wire in the vicinity of the borehole while making measurements of the apparent Earth magnetic field in a borehole that is being tracked. These measurements are preferably made using an industry standard steering tool in the borehole. The switching apparatus generates a set of precisely timed, positive polarity and negative polarity DC current flows in a source guide wire loop laid out on the Earth's surface. The current flows are precisely synchronized with the apparent Earth magnetic field measurements. Apparatus is disclosed for encoding this synchronization into the electromagnetic field and thus into the apparent Earth magnetic field measurements themselves. Precise synchronization of the field measurements with the electric current flow in the source loop makes it possible to multiply the apparent Earth field measurements by an appropriate reference waveform and to average the results to evaluate the required electromagnetic field amplitudes. These field-averaged amplitudes are then used to match theoretically computed amplitudes to determine the location of the sensors, in order to precisely track the drilling or the survey of the borehole.

In addition, a method is disclosed whereby an ensemble of the apparent Earth field measurements can be used to determine the uncertainty of the sensor location determination. In accordance with this method, the noise fluctuation in the apparent Earth field measurements is found by computing the standard deviation of these measurements after the theoretical electromagnetic field, found from the signal averaging procedure, has been subtracted off. Alternatively, independent measurements of the apparent Earth's field can be carried out with no current flow in the source loop for the purpose of evaluating their standard deviation. The standard deviation is then used to set the amplitude of an ensemble of random numbers.

The electromagnetic fields of a simulated ensemble of surveys are then generated for a selected location, using theoretical electromagnetic fields for that location and adding to each of these values a magnetic field noise generated by a random number generator with the measured standard deviation of the measured fields. The location associated with each of these surveys in the ensemble is then computed and the standard deviation of the locations found for the ensemble of surveys is computed to determine the expected uncertainty; i.e., the expected standard deviation of the location determination.

### BRIEF DESCRIPTION OF DRAWINGS

The foregoing, and additional objects, features and advantages of the invention will become apparent to those of ordinary skill in the art from the following detailed description of preferred embodiments thereof, taken in conjunction with the accompanying drawings, in which:

FIG. 1. is a diagrammatic illustration of a borehole tracking system for a generally horizontal borehole in accordance with one embodiment of the invention;

FIG. 2. is a diagrammatic illustration of the DC switching apparatus and of the flow of data and control signals for the embodiment of FIG. 1;

FIG. 3. is a diagrammatic illustration of the timing generated by the apparatus in FIG. 2;

FIGS. 4(a) and 4(b) are side and end views of a diagrammatic illustration of an idealized current source and borehole geometry used to model, and to show the results of, data averaging;

FIG. 5 is a flow chart illustrating a method of computing sensor location using the field averaging of the invention, with the results of this method being shown in Table 1;

FIG. 6 is a flow chart illustrating a method of computing sensor location using a method of location averaging, with typical results of this method being shown in Table 2;

FIG. 7 is a flow chart of steps used to compute expected standard deviation in location determination, using apparent Earth field measurements and location coordinates of a point in a borehole;

FIG. 8 is a flow chart of steps to synchronize a freely running DC switched current source with a stream of apparent Earth field measurements;

FIG. 9 is a graph illustrating the results of using the steps shown in FIG. 8 to synchronize measurements of the apparent Earth's magnetic field with a positive current duration of 50% in the source loop and an actual start time of 1.5 seconds, with a noise parameter equal to 1 and equal to 0; and

FIG. 10 is a graph illustrating results obtained using the steps illustrated in FIG. 8 to synchronize measurements of the apparent Earth's magnetic field with a positive current duration of 60% in the source loop, an actual start time of 1.5 seconds, and a standard deviation equal to the theoretical field as defined herein.

### DESCRIPTION OF PREFERRED EMBODIMENTS

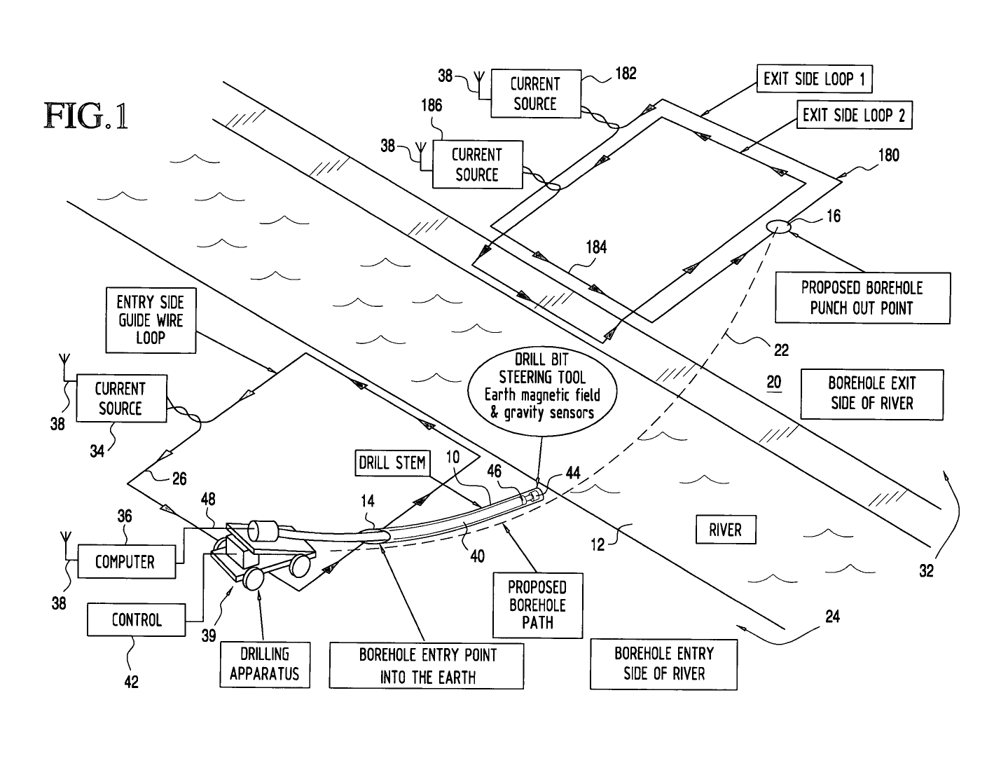

Turning now to a more detailed description of the present invention, FIG. 1 illustrates the methods of the present invention in the context of an important application, where a borehole 10 is to be drilled under an obstacle such an electrified railroad, or a river 12 which may have heavy boat traffic, as part of a pipeline or transmission cable project. It will be understood, however, that the illustrated embodiment is exemplary, and that the described methods and apparatus can be used in a wide variety of applications. The borehole 10 has a prescribed entry point 14 and a prescribed exit point 16 on the Earth's surface 20 and is to precisely follow a predetermined, planned or “proposal” path 22, i.e., to within a few meters of the proposal path.

Above the path 22, in the region of the entry point 14 located, for example on the near side 24 of river 12, a loop 26 of wire is laid out on the surface of the earth and preferably to one side of the path. The surface elevation, and the north and east coordinates of multiple points specifying the surface loop configuration are determined using standard land surveying techniques. Logical reference points for the loop 26 are the specified borehole entry point 14 or the proposed exit point 16 on the far side 32 of the river, for example, if the borehole is to exit the ground. A direct current source and an electronic switching circuit 34 are connected to, and provide power to the wire loop. This switching circuit may be directly controlled by a computer 36, using a telemetry link 38, or by a simple stand-alone unit with an independent, precise clock, which may or may not be physically synchronized with the steering tool data stream. Means for measuring the current flow are also incorporated into current source and switching unit 34.

The borehole 10 is drilled using conventional drilling apparatus 39 which includes a drill stem 40 of precisely known length, control circuitry 42 at the near, or up-hole end for controlling the direction of drilling, a drilling bit 44 and an electronic steering tool 46 at the down hole end of drill stem 40, and conventional apparatus for communicating steering tool measurements up hole to computer 36 at the Earth's surface, as by way of cable 48. Steering tool 46, which is standard to the drilling industry, incorporates three orthogonally-related Earth's magnetic field sensors and three orthogonally-related accelerometers used as gravity sensors. These sensors and accelerometers are used determine the drilling direction and the roll angle of the “tool face” for measuring the direction of drilling and determining the orientation of the steering tool itself, and this information is supplied to the computer 36 to enable control 42 to change the direction of drilling.

In accordance with the present invention, an ordinary, measurement while drilling tool (MWD) or an unmodified steering tool 46 is used with a reversible direct current flowing in the loop 26 to determine the precise location of the steering tool in the borehole, to provide a precise measurement of the borehole location for drilling control or for borehole survey. The precise location is established by exciting the loop from the direct current power source and switching unit 34 and by precisely controlling the direction, or polarity, of the current flow in the loop in synchronization with the measurement timing clock used in the MWD, or steering tool. Direct synchronization of the timing clock with the direction of current flow in the loop is achieved, for example, by way of the computer 36, which is connected to the steering tool, and the direct communication link 38 between the computer and the DC current switching unit 34. The direct current flowing in loop 26 generates an electromagnetic field in the Earth in the region of the borehole 10 and its proposed path 22, which field is superimposed on the Earth's magnetic field to produce at the steering tool an apparent Earth's magnetic field. The X, Y and Z vector components of this apparent Earth's magnetic field are measured by the field sensors in the steering tool, and a sequence of such measurements are made with known positive and negative polarity current flowing in loops 26. Usually, a direct current of approximately 50 amperes in each direction is sufficient.

The Earth's field is found from a weighted average of the apparent Earth field measurements, while the electromagnetic field is obtained from a weighted difference computation of these measurements. The sensor location may be determined from computations of the theoretical electromagnetic field generated by the loop at various trial locations, and matching these calculations with the electromagnetic field measurements. Computation of the electromagnetic field vector components generated by the loop current at any location in the borehole is readily carried out, since the roll angle, azimuth direction, and inclination of the sensors is known from standard analyses of the steering tool measurements of Earth Magnetic field and gravity. Alternatively, the x, y and z measurements, given by the sensor voltages are readily transformed to the land surveyor's coordinate directions.

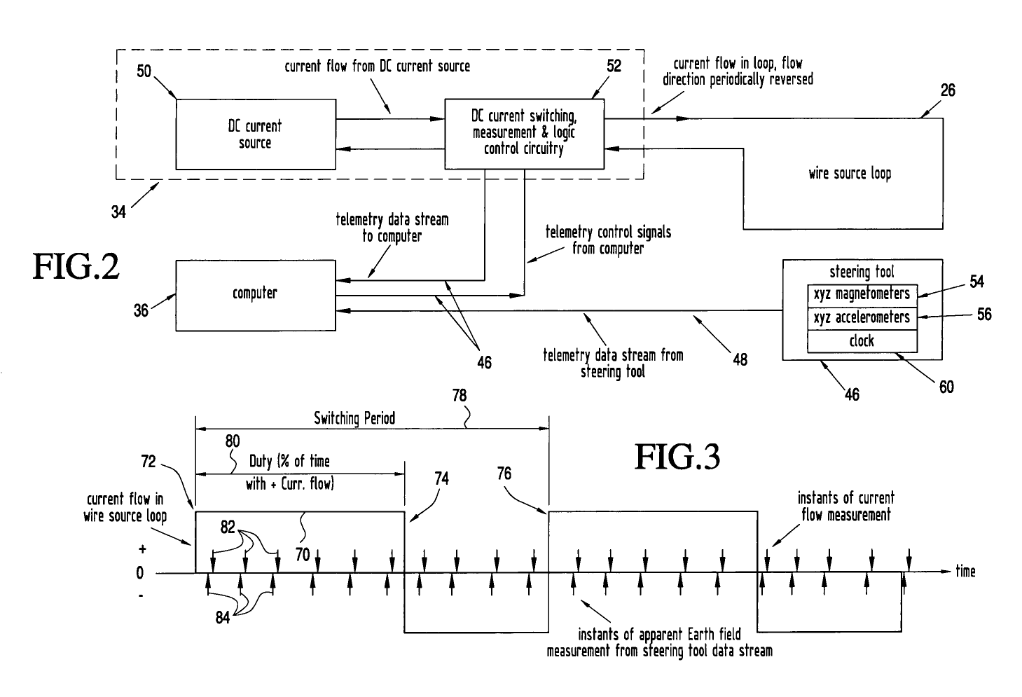

Turning now to a more detailed description of the present invention, FIG. 2 illustrates in the block diagram form the apparatus being employed. The current source and switching unit 34 includes a direct current source such as a DC welder 50 connected to supply power to electronic switching circuit 52, which is used to supply power of a selected polarity to energize wire loop 26 on the surface of the Earth. Steering tool apparatus 46 in the borehole 10 senses the total magnetic field including the Earth's magnetic field and the generated electromagnetic field, near the drill bit 44. In the borehole, whose drilling progress is being tracked, the steering tool 46, which includes x, y and z Earth field measuring magnetometers 54 and x, y, and z gravity measuring accelerometers 56, telemeters measurement data by way of connector 48, which, for example, may be a wire line or may be in the form of pressure pulses in the drilling fluid, to computer 36 at the Earth's surface.

Industry standard steering tools 46 typically sample each component of the “Earth's magnetic field”, or the total magnetic field at the sensor location, at about once per second under the control of a clock 60, which may be part of the steering tool. This total magnetic field, which includes the generated magnetic field, any ambient magnetic noise superimposed on the Earth's magnetic field and any instrumental noise, may be referred to as the apparent Earth's magnetic field. In order to separate and identify the generated field from measurements of the apparent Earth's magnetic field at any sensor location, in accordance with the invention, the direct current flowing in the loop 26 in periodically reversed. The period between reversals of the polarity of the loop excitation should be greater than the sampling time of the steering tool. In practice, it is necessary to change polarity often enough to allow for field settling and for synchronization between the steering tool field measurement cycle, controlled by clock 60, and loop current reversals, controlled by switching circuitry 52. It is also important to switch polarity often enough to eliminate the effect of a slowly drifting value of the apparent Earth's magnetic field. For this combination of parameters, it is desirable to switch current polarity about every 4 or 5 seconds. The relationship between current flow in the loop 26 and the times of field measurement by steering tool 46 are illustrated FIG. 3. The current flow in the loop is illustrated by curve 70, which illustrates a switch to a positive polarity at 72, to a negative polarity at 74, and back to the positive polarity at 76, over a selected switching period indicated at 78. As illustrated, the current has a duty time 80, which is the percentage of the switching period when there is a positive current flow. As also shown in this Figure, the current flow in loop 26 is measured periodically, as indicated by arrows 82, and the apparent Earth field is also measured periodically, as indicated by arrows 84. In accordance with the invention and as illustrated in FIG. 3, the duty cycle of the positive current flow, i.e. the fraction of the switching period when the loop current is positive, is not equal to 50%. When this is the case, the precise synchronization of the apparent Earth field measurements with the time at which the current flow in loop 26 switches to its positive direction can be determined by the measurements themselves.

The computer 36 can be used to control the electronic switching circuitry 52 in synchronism with the serial Earth Field data from the steering tool, as illustrated in FIG. 3. Computer 36 receives and decodes the telemetry data stream received from the steering tool 46 by way of connector 48. The data stream from the steering tool consists of continually repeating measurement data blocks governed by the steering tool clock 60 with precise timing but with an unknown absolute time reference. FIG. 3 shows at 84 the relative timing of one component of the apparent Earth Field measurement; in reality, the data stream from the steering tool will have three components of Earth Field measurement and three components of gravity in each measurement block. The DC switching control circuitry 52 generates the sequence of DC switching, current measurement, and apparent Earth Field measurement, as illustrated in FIG. 3, but with a known reference to the data stream from the steering tool by way of computer 36. The use of the computer 36 to recognize the switching instants for the DC current flow in relation to the stream of apparent Earth Field measurements is an important aspect of the present invention. The current flow into loop 26 is switched as shown, directly from a positive current flow to a negative current flow, or first with a positive current flow, then zero, and then a negative current flow.

The efficacy of precisely timed DC current switching and field averaging in the presence of high noise is shown in Tables 1, 2 and 3. Table 1 shows the results of using the system of field averaging being disclosed:

TABLE 1

| | | | | Standard | | | Standard |
|---|---|---|---|---|---|---|---|
| Relative Noise | Number of | | | Deviation Rg H | | | Deviation |
| Power | Measurements | Rg true | Rg Haverage | average | Rr true | Rr Haverage | RrHaverage |
| 0.1 | 600 | 100 | 100.0 | 1.4 | 30 | 30.0 | 1.4 |
| 0.2 | 600 | 100 | 100.0 | 1.9 | 30 | 29.9 | 1.9 |
| 0.5 | 600 | 100 | 100.0 | 3.1 | 30 | 29.9 | 3.0 |
| 1.0 | 600 | 100 | 100.0 | 4.3 | 30 | 30.0 | 4.2 |
| 2.0 | 600 | 99.9 | 99.1 | 6.1 | 30 | 30.0 | 6.0 |
| 1.0 | 2400 | 100 | 100.0 | 2.1 | 30 | 30.0 | 2.2 |

Table 2 shows the results of using the prior art method in most common use as disclosed in U.S. Pat. No. 4,875,014:

TABLE 2

| Relative | Number of | | | Standard Deviation Rg | | | Standard Deviation Rr |
|---|---|---|---|---|---|---|---|
| Noise Power | Measurements | Rg true | Rg coordinate average | coordinate average | Rr true | Rr coordinate average | coordinate average |
| 0.1 | 600 | 100 | 100 | 1.6 | 30 | 30.1 | 1.6 |
| 0.2 | 600 | 100 | 99.4 | 3.2 | 30 | 29.6 | 3.6 |
| 0.5 | 600 | 100 | 86.6 | 6.9 | 30 | 26.1 | 9.0 |
| 1.0 | 600 | 100 | 63.3 | 9.6 | 30 | 18.6 | 14.8 |
| 2.0 | 600 | 99.9 | 39.4 | 9.4 | 30 | 11.8 | 8.4 |
| 1.0 | 2400 | 100 | 63.1 | 4.7 | 30 | 19.0 | 4.7 |

Table 3 shows the results of using the apparatus and methods disclosed using the prior art method of U.S. Pat. No. 6,466,020:

TABLE 3

| | Number of | | | Standard Deviation | | | Standard Deviation |
|---|---|---|---|---|---|---|---|
| Relative Noise Power | Measurements | Rg true | Rg Haverage | Rg H average | Rr true | Rr Haverage | RrHaverage |
| 0.1 | 600 | 100 | 99.9 | 1.9 | 30 | 30.0 | 1.9 |
| 0.2 | 600 | 100 | 100.0 | 2.7 | 30 | 30.0 | 2.7 |
| 0.5 | 600 | 100 | 100.0 | 4.2 | 30 | 30.0 | 4.3 |
| 1.0 | 600 | 100 | 99.8 | 6 | 30 | 30.1 | 6.0 |
| 2.0 | 600 | 100 | 100.1 | 8.5 | 30 | 29.7 | 8.6 |
| 1.0 | 2400 | 100 | 100.0 | 3.0 | 30 | 30.0 | 3.0 |

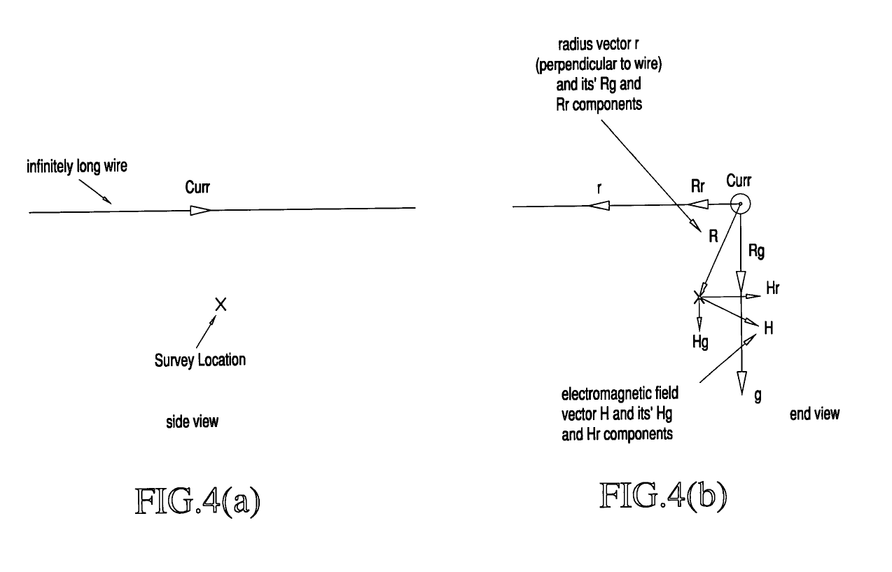

All three tables assume the same geometry, random magnetic noise and peak voltage applied to the loop. The assumed geometry is an idealization of the loop 26, borehole 10, and steering tool 46, as illustrated in FIG. 1. The symbol definitions are as shown in FIG. 4. For purposes of the following calculations, it is assumed that loop 26 is an infinitely long wire that carries an electric current Curr. The steering tool 46 has location coordinates Rg down and Rr right relative to the wire 26. This case is a good case to consider since it is close to representing typical cases and it is easy to compute analytically. The relationships between the electromagnetic field components Hg in the gravity direction (i.e., down) and Hr in the horizontal plane (in amperes/meter), and the location coordinates Rg and Rr are given by:
Hg=(Curr/(2*pi))*Rr/(Rrˆ2+Rgˆ2)
Hr=−(Curr/(2*pi))*Rg/(Rrˆ2+Rgˆ2) (Eq. 1)
and the inverse:
Rg=−(Curr/(2*pi))*Hr/(Hrˆ2+Hgˆ2)
Rr=(Curr/(2*pi))*Hg/(Hrˆ2+Hgˆ2) (Eq. 2)

Equations 1 and 2 show that one can readily go back and forth between measured fields and location analytically. For this geometry, given the apriori knowledge that the field measurement location lies below the wire, location can be uniquely determined without knowledge of the direction of current flow. With more complex source configurations, the need to know the direction of current flow for each apparent Earth field measurement can be vital.

The results tabulated in Tables 1, 2 and 3 are for a location with a vertical depth Rg of 100 meters and a distance Rr of 30 meters the right, with a DC source current Curr of 50 amperes. A relative noise power=1 corresponds to a standard deviation of about 96 nano-Tesla (0.08 microamps/meter) for each vector component of an ensemble of apparent Earth field measurements. At the location being considered, a current flow of 50 amperes generates a total electromagnetic field magnitude of 96 nano-Tesla, i.e., 0.08 amperes/meter. The first five lines of each table are for a total of 600 measurements. The relative noise power of each vector component of an ensemble of measurements is the variance of the field relative to the “field power” i.e.,
NoisePower=average(EarthFieldvaluesˆ2)−(average(EarthFieldValues))ˆ2
EMFieldPower=(Curr/(2*pi))ˆ2/(Rgˆ2+Rrˆ2)
RelativeNoisePower=NoisePower/EMFieldPower (Eq. 3)

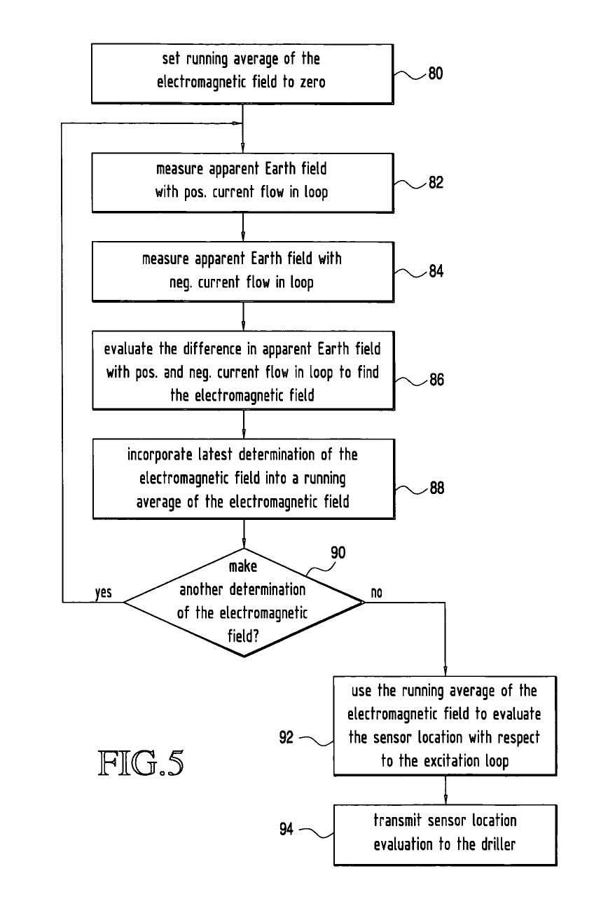

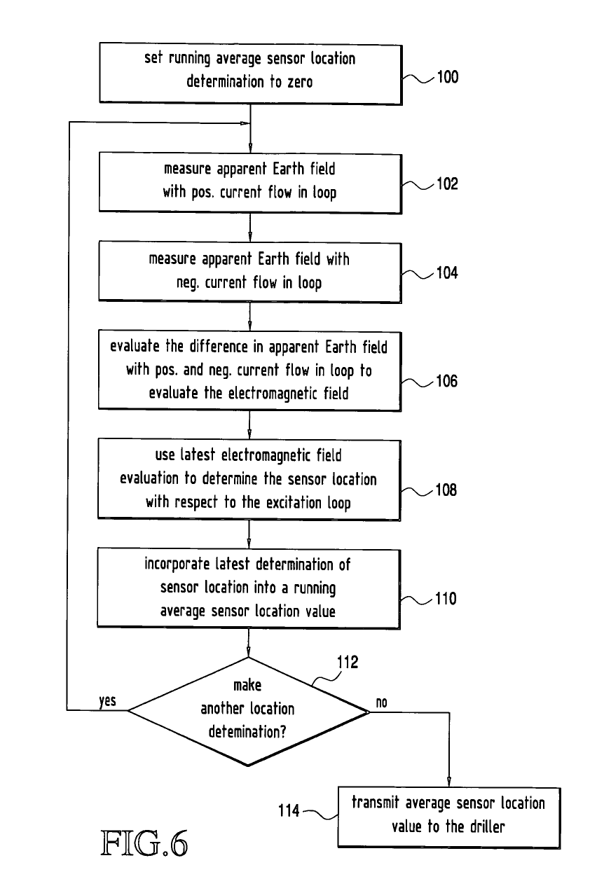

Tables 1 and 2 show the values of Rg and Rr and the standard deviations derived from simulated electromagnetic field measurement data using a magnetic field (H) averaging method and by the coordinate averaging method in common use today for manually switched DC excitation of a guide loop. These tables were computed using the procedures illustrated by the flow diagrams shown in FIGS. 5 and 6. In FIG. 5, after resetting the system to zero, as illustrated at box 80, the apparent Earth's magnetic field is measured during a positive current flow in loop 26, as indicated at box 82. Thereafter, the apparent Earth's magnetic field is measured with a negative current in loop 26 (box 84), and the difference between the measurement fields is evaluated to find the electromagnetic field at the sensor location (box 86). The result of this evaluation is then incorporated into a running average of the electromagnetic field, as indicated at box 88. Repeated determinations of the electromagnetic field are made (box 90), and when a sufficient number of determinations have been made, the running average of the measured electromagnetic field is used to evaluate the location of the sensor with respect to the excitation loop 26, as shown at box 92, and the evaluation is transmitted to the driller for us in controlling further drilling (box 94). The values in Table 1 were obtained using this procedure.

FIG. 6 illustrates another procedure for determining sensor location, wherein after reset (box 100), the apparent Earth's magnetic field is measured with a positive current flow in loop 26 (box 102) and then with a negative current flow (box 104). The difference in the apparent fields is evaluated (box 106) and in this process, the latest electromagnetic field evaluation is used to determine the sensor location with respect to the excitation loop 26 (box 108). Then the latest location determination is incorporated into a running average sensor location value (box 110), and if another location determination is to be made, the process is repeated, (box 112). If additional determinations are not required, the average sensor location value is transmitted to the driller (box 114). Computations based on the process of FIG. 6 are found in Table 2.

The important difference between the procedures of FIGS. 5 and 6 is the order in which the averaging steps are carried out. With electromagnetic field averaging, (FIG. 5), the values of the electromagnetic field measurements are averaged before computing a set of survey location coordinates. With location coordinate averaging (FIG. 6), each measurement of the electromagnetic field is used to determine a location. This is done over and over to obtain an ensemble of locations whose coordinate values are then averaged and the values transmitted to the driller.

When the relative magnetic field noise power is 20% or less, both the field averaging method and the coordinate averaging method give essentially correct values for both Rr and Rg. However, the coordinate averaged values for Rg and Rr found for a relative noise power of 50% or more are unacceptable. Electromagnetic field averaging always gives the correct “average” expectation for both Rg and Rr. Comparing the entries for 2400 field measurements with 600 coordinate measurements computed by these procedures shows that the uncertainty of the coordinate determinations of Rg and Rr decreases with the square root of the “Noise Power” or of the “Number of Field Measurements”, as expected for both methods.

Table 3 uses the same parameters as Tables 1 and 2 except that the current excitation for loop 26 is a sinusoidal AC with the same peak voltage as was used in the switched DC methods. The analysis used to produce this table follows the method disclosed in U.S. Pat. No. 6,466,020. A least squares method is used to optimally determine the appropriate sinusoidal component of the electromagnetic field present in the ensemble of measurements made during a survey. The standard deviation of the location determination obtained in this way is 1.4 times that of the electronically switched DC method of the present invention. Double the measurement time is thus required to produce a given precision in the location determination using AC current excitation than is required for the process of the present invention.

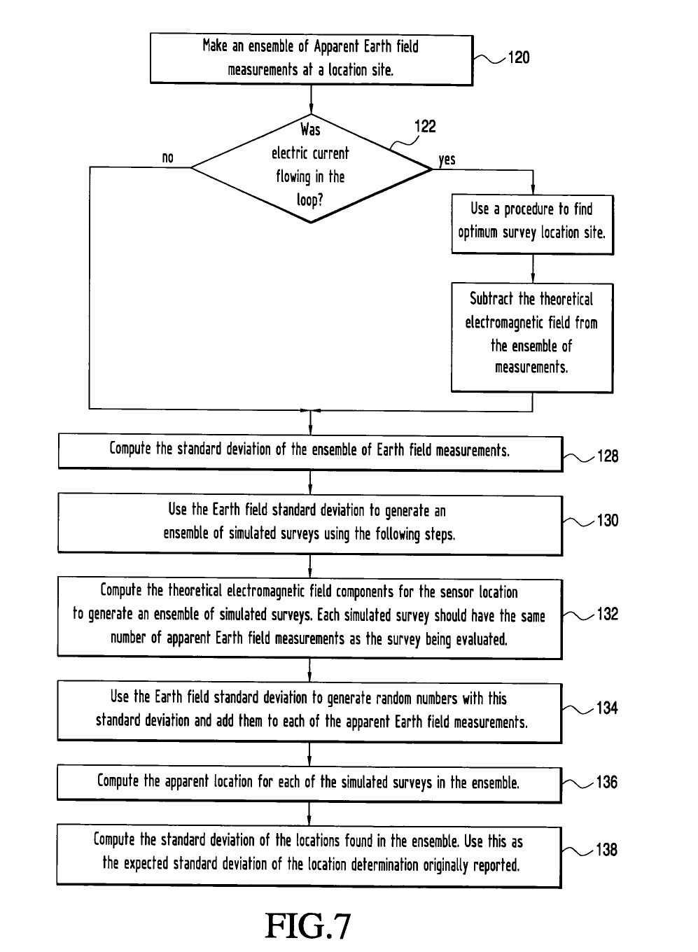

Uncertainty estimates of a location determination are particularly important when much noise is present. The Flow Chart shown in FIG. 7 discloses a way of doing this. After making an ensemble of apparent Earth field measurements at a location (box 120) an estimate of the standard deviation of the apparent Earth field measurements with no electromagnetic field present is first done. This can be done either with no current flowing in the loop (box 122) or with the theoretical electromagnetic field present in the survey subtracted off (boxes 124 and 126). The standard deviation found (box 128) is used in conjunction with a random number generator to generate an ensemble of simulated surveys (box 130) with similar measurement fluctuations. The apparent location of each survey simulation is computed (boxes 132, 134 and 136) and the standard deviations of the locations found are computed (box 138). This method was used to find the standard deviations of location in Tables 1, 2 and 3. To compute the location standard deviations in these tables an ensemble of 3000 simulated surveys was used in each case. This required somewhat less than 1 second on the personal computer used. It is often useful to reject measurements that lie far outside the limits indicated by the standard deviation of measurements before doing the evaluation of the location coordinate standard deviations.

To synchronize the clock controlling the measurement data stream 48 from the steering tool and the DC current switching circuitry, the system with the electronic control circuitry 52 described above works very well and requires a minimum of computer programming since the time relationship between the measurements of current and field and of the times of current switching are known directly. However this does require a two-way flow of data between the electronic control circuitry and the steering tool by way of computer 36. In many circumstances, particularly when the DC current source 50 and the loop 26 are at remote locations, it is desirable, or even necessary, to use a DC current source and switch, which has more “stand alone” capability.

One form of such a current source is a current source controlled by an operator at the location of current source 34 with a standard construction site walkie-talkie. The operator at this site turns the unit on and off before and after a survey, reads the average current flow, and relays this information to an operator at computer 36. The DC switching and current measuring circuitry 52 can be synchronized by such a system if the central computer 38 couples an acoustic control starting tone into the walkie-talkie system. The speaker output of the walkie-talkie is then used to start the controlling clock at the current switching apparatus location 34 when the sensor tool data stream is received. At the end of a survey the value average current flow is relayed back by the operator verbally, or electronically using an acoustically encoded average current measurement generated by the switching apparatus.

An alternative DC current switching system can use absolutely synchronized crystal oscillators or simultaneous time signals taken from two GPS (global positioning satellite) units, one connected to the computer 36 and the other to the current switching unit 34. Even if direct control to the times of switching is not provided, the times of measurement and the times of switching can be synchronized in the sense that the relationship between the two times is known.

The simplest and most desirable current source 34 is one where the switching circuitry unit runs freely, with essentially no communication between the driller and the current source except by means of the electromagnetic field that is generated by the current in loop 26. In this case, the average DC current flow from the source is measured and is assumed to remain constant during a survey. The current source switches with a precisely known period and duration time fraction between positive and negative polarities, as shown in FIG. 3. An analysis of the data stream itself is then used to synchronize the timing between the source and the measurements.

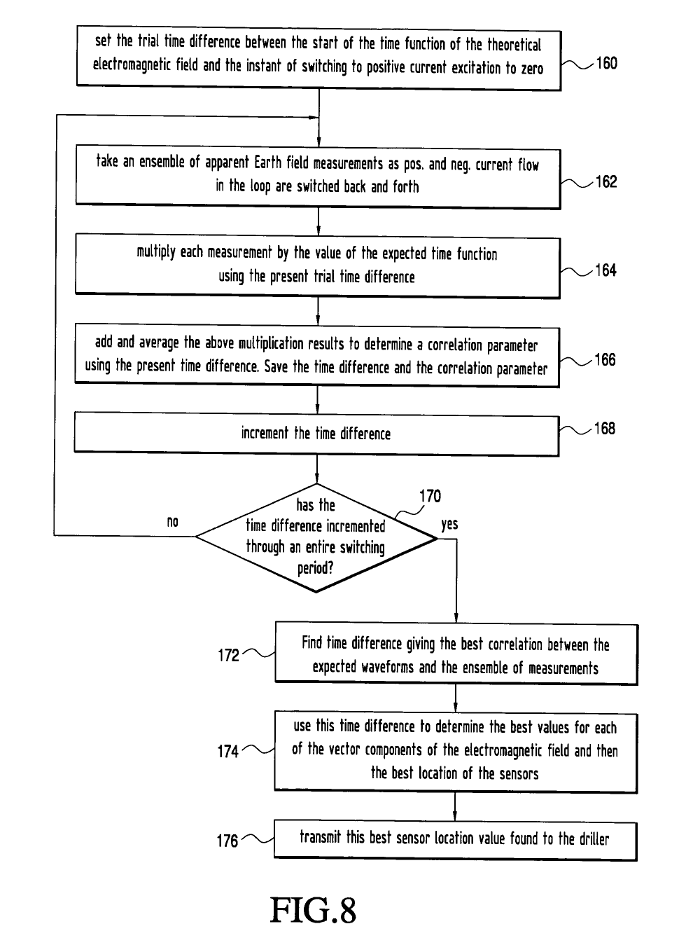

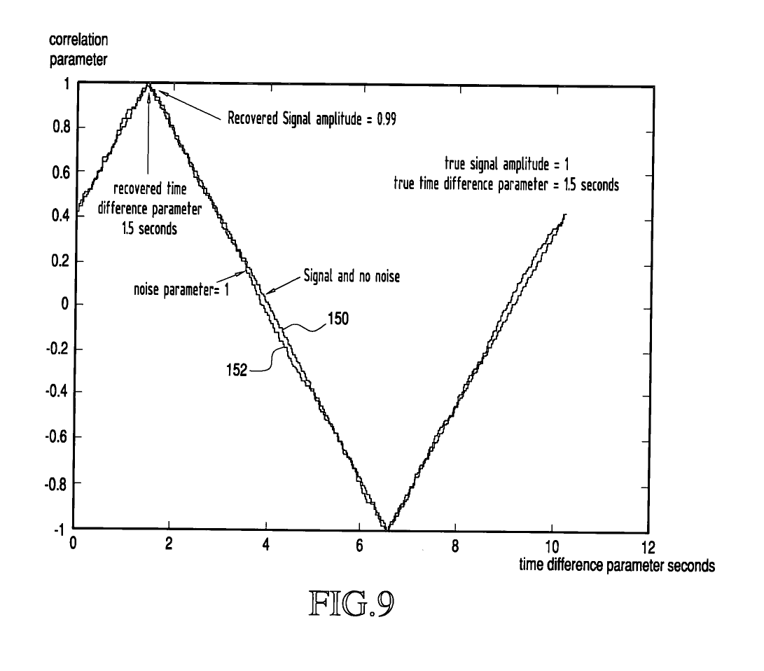

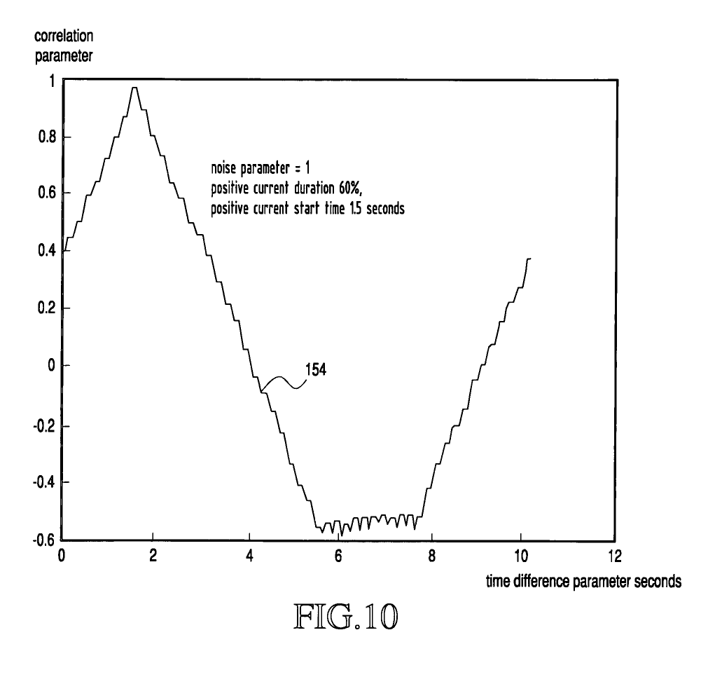

The Flow Diagram in FIG. 8 shows a procedure to do this synchronization, and the results generated by this procedure are shown in FIGS. 9 and 10. FIG. 9 shows at curves 150 and 152 the results of using a symmetric square wave current source, i.e., a current source with equal durations for positive and negative current flow. A sequence of 612 measurements of one magnetic field component, sampled at the rate of one sample per second, is shown. The current source, in the example given, is switched with a period of 10.2 seconds; after 612 measurements, 60 complete cycles of current polarity change have occurred. The field amplitude modeled has amplitude 1. The results of two data sets are plotted in FIG. 9. The first set, indicated by curve 150 has no magnetic noise and symmetric positive and negative current flow in the loop, while the second curve 152 has random noise with a standard deviation equal to the signal field added. For this case, the procedure returned the apparent magnetic field amplitude of 0.99 instead of 1.00 after noise was added and the correct “cycle” starting time of 1.50 seconds. In general, neither the polarity nor the amplitude of the electromagnetic field components is known beforehand. In this case, with symmetric square wave excitation absolute synchronization is not possible since the correlation function found is sign symmetric.

FIG. 10 shows at curve 154 the results with positive current flowing 60%, and negative current flowing 40% of the time, with the signal-to-noise parameter equal to 1. When the absolute synchronization is correct, the correlation is close to 1, as shown in FIG. 9. As the figure indicates, only the correct reference time difference gives perfect correlation between the apparent Earth field measurements and the current reference function. In general, each of the vector components of the Earth's magnetic field will have a large and unknown value. The effect of this will be to add a zero offset to the plot shown in FIG. 10. The shape of the plot indicated in FIG. 10 is, however, preserved.

The flow chart shown in FIG. 8 illustrates the principle. Initially, as indicated at box 160, the trial time difference between the start of the time function of the theoretical electromagnetic field and the instant of switching the positive current excitation is set to zero. Thereafter, at 162, an ensemble of apparent Earth field measurements are taken as positive and negative current flows in the loop 26 are switched back and forth. Each apparent Earth field measurement is multiplied by the values of a “reference square wave” whose functional form matches that of the current source, as indicated at box 164. It has the same period, in the case shown, 10.2 seconds, and duty cycle but unknown time difference between the measurement clock in the steering tool and the excitation clock for the control circuitry 52. Using an excitation period which is slightly different from an exact multiple of the steering tool sampling period is often desirable since it minimizes the effects of switching transient errors associated with the finite rise and fall time of current flow into the source loop.

A sequence of time differences is chosen and the correlation between the measurements and the reference square wave is computed for each time difference. as indicated at box 166. Once the correlations for the time difference parameter spanning an entire period of the reference function have been found, the time difference having the maximum correlation is taken as the correct time difference. Usually it is best to use the strongest vector component of the electromagnetic field to find the time difference between the clocks and then to use this time difference to compute subsequently the field averages of each of the 3 vector components of the electromagnetic field. With the reference square wave absolutely synchronized with the alternating polarity timing of the signal, this procedure effectively subtracts measurements with negative current from those with positive current as desired. If the “time registration” between the assumed reference square wave and signal is incorrect a smaller result is produced. To produce the graphs shown in FIGS. 9 and 10 the starting time of the reference square wave is “slid” at 0.05 second increments, as indicated at boxes 168 and 170, and the resulting ensemble of signal correlations computed. The maximum signal correlation (box 172) is equal to the best estimate of the signal magnitude and is approximately equal to the true signal amplitude as the figure shows. The delay time at which the maximum value occurs is the delay between the reference square wave and field “square wave”. The above correlation can also be computed using a well-known equivalent method using Fourier transforms.

Another way to synchronize the clocks is to compute the Fourier amplitudes and phases of the fundamental frequency associated with the period of switching and of its second harmonic. For the case of symmetric excitation the relative phase of the fundamental frequency component can be used for synchronization with inherent sign ambiguity. For asymmetric current excitation the phases of the fundamental and of the second harmonic can be used to determine absolute synchronization.

Once the time difference which gives the best correlation between ththeheoretical or expected, waveforms and the ensemble of measurements is found, this time difference is used to determine the best values for each of the vector components of the electromagnetic field (box 174) and from this, the best location of the sensors in the steering tool. These vector component values are then transmitted to the driller (box 176) for use in controlling further drilling of the borehole, in the case of a drilling operation, or for use in identifying the location of an existing borehole, in the case of a borehole survey.

Although the foregoing description has reference to a current loop 26 located in the vicinity of the borehole, and particularly in the region of the known borehole entry location, it will be understood that the excitation current can be generated at other locations along the length of the projected path 22. For example, as also illustrated in FIG. 1, an exit side excitation loop 180 may be provided in the region of the proposed borehole punchout point 16. In this case, the loop 180 is excited by a current source 182, which is similar to current source 34 and which is controlled by computer 36 by way of telemetry link 38, as described above. Another loop 184 controlled by current source 186 is illustrated as being positioned at a different location along the path 22.

Although the invention has been described in terms of preferred embodiments, various modifications may be made without departing from the true spirit and scope thereof, as set forth in the following claims.

What is claimed is:

1. Apparatus for tracking the progress of a borehole made by a drilling assembly comprising:
a conductive loop of wire in the vicinity of the borehole;
a direct current power source connected to said wire loop;
a magnetic field sensor located in the borehole;
a controlled switching apparatus for repeatedly reversing the direction of electric current flow in the loop to produce a reversing electromagnetic field detectable by said sensor measuring the apparent Earth's magnetic field;
a current detector for measuring the electric current flow in the wire loop;
circuitry for synchronizing the apparent Earth's magnetic field measurements and changes in the direction of current flow in the wire loop; and
means responsive to the said Earth's magnetic field measurements and the current flow measurements for determining the location of the said magnetic field sensor.

2. The apparatus of claim 1 wherein the means for determining the location of the said magnetic field sensor includes matching the location along the borehole where the measured apparent Earth field measurements most nearly fit calculated electromagnetic magnetic field vector components.

3. The apparatus of claim 1, including a measurement clock 40 controlling said sensor.

4. The apparatus of claim 3, wherein the apparatus includes a clock controlling said switching apparatus.

5. The apparatus of claim 4, wherein said circuitry utilizes the time difference between said excitation and measurement clocks to correlate the direct current flow in said wire loop with the measurements of said apparent Earth's magnetic field for said synchronization.

6. The apparatus of claim 1, wherein said controlled switching apparatus is an electronically controlled direct current switching, measurement and logic control circuit for controlling the direction and duty cycle of the current flow in said loop.

7. A method for tracking the location of a borehole, comprising:
positioning a magnetic field sensor in the borehole for measuring the vector components of the apparent Earth's magnetic field;
positioning a conductive wire loop in the vicinity of the borehole;
generating in said conductive wire loop a direct current of known magnitude;
periodically reversing the polarity of said direct current, the reversing current having a known period and duty cycle, to produce a corresponding electromagnetic field in the region of said magnetic field sensor;
periodically measuring the apparent Earth's magnetic field at said sensor;
synchronizing the apparent Earth's magnetic field measurements with the periodic reversal of the polarity of said direct current;
signal averaging the apparent Earth's magnetic field measurements to extract the vector components of said electromagnetic field in the region of said sensor; and
determining the coordinates of the location of said sensor from the measured electromagnetic fields and theoretical electromagnetic fields determined from the generated direct currents.

8. The method of claim 7, wherein the step of synchronizing includes correlating apparent Earth's magnetic field measurements with a time function of the reversing direct current in said loop.

9. The method of claim 8, wherein the step of correlating includes determining the best correlation between the apparent Earth's field measurements and the time function of the reversing direct current for different selected time differences.

10. The method of claim 9, wherein the step of correlating includes Fourier transform techniques for determining the best correlation.

11. The method of claim 8, wherein the step of synchronizing includes asymmetrically reversing the polarity of said direct current to obtain absolute synchronization.

12. The method of claim 7 including determining the uncertainty of the location of the sensor found utilizing observed noise fluctuations of apparent Earth magnetic field measurements and evaluation of the electromagnetic field

13. The method of claim 12 including deriving a parameter characterizing said observed noise fluctuations of the apparent Earth's magnetic field and the computation of the location uncertainty using said parameter.

14. The method of claim 13 wherein the location uncertainty computation includes constructing an ensemble of simulated apparent Earth field measurements that incorporate random noise with said noise characterization parameter to compute an ensemble of location determinations from which the location uncertainty is determined.
